(19) United States
(12) Patent Application Publication
(10) Pub. No.: US 2005/0116909 A1
(43) Pub. Date: Jun. 2, 2005

(54) Video speed STN display

(76) Inventor: Yao-Dong Ma, Frisco, TX (US)

Correspondence Address: Yao-Dong Ma, 14586 Pensham Dr., Frisco, TX, 75035, US

(21) Appl. No.: 10/727,295

(22) Filed: Dec. 2, 2003

(51) Int. Cl. G09G 3/36

(52) U.S. Cl. 345/87

(57) ABSTRACT

The present invention relates to a liquid crystal display, especially, to a video speed STN display with high contrast ratio. The display provides not only a flicker-free video speed with 30 frames per second, but also a high display quality, such as full color gamut, high contrast ratio and high brightness and so on. The video speed display is realized by the optimization of the display cell structure, the liquid crystal formulation and the driving circuitry.

### FIELD OF INVENTION

The present invention relates to a liquid crystal display, especially, to a video speed STN display with high contrast ratio. The display provides not only a flicker-free video speed with 30 frame per second, but also a high display quality, such as full color gamut, high contrast ratio and high brightness and so on. The video speed display is realized by the optimization of the display cell structure, the liquid crystal formulation and the driving circuitry.

### BACKGROUND OF THE INVENTION

Super twist nematic (STN) liquid crystal display is characterized by the fact that the information content can be as high as video-graphic-array resolution using a passive matrix drive scheme. As a special TN display, STN was discovered during 1980s that the steepness of the electro-distortional curve could be dramatically increased by increasing the layer twist angle from 90° to 270°. A steep electro-distortional curve is a precondition to achieve high contrast passive matrix displays capable of binary or gray levels on applications requiring a high information content. To sustain a twist angle greater than 90° requires a nematic liquid crystal with an intrinsically twisted structure known as a chiral nematic. Chiral nematics are ordinary nematic liquid crystals doped with a few percent of optically active material, i.e. cholesteric material. The handedness of the cholesteric material imparts an intrinsic macroscopic twist to the whole nematic structure. The amount of twisting is characterized by a pitch length P, which is the distance measured along the helical axis for the director rotated by a full 360°. When the chiral nematic is filled into the cell, the directors at the substrate planes anchor along the alignment directions and the pitch length is expanded or compressed relative to its intrinsic value.

The yellow background of the first STN displays was not well accepted by people who is used to the black-and-white and full color display. The double layer STN announced in 1987, was first to full satisfy the requirements for a bright, achromatic STN display. Two drawbacks of the double layer STN are the increased display thickness and weight. Experiments to replace the compensating cell with a thin cholesteric polymer film have been successful, and these films have now moved into the production phase. The use of polymer film retarder layers in combination with STN displays was proposed in 1983, and finally made a product in 1989 under many names. It turns out that reasonable compensation can already be obtained with just one or two retardation sheets. Optical negative polymeric films composed of discotic molecules have recently been developed for wide viewing angle STN displays.

However, one of the main shortcomings of STN display compared with the current active matrix TFT display is the slow response time. This is the exact reason why it was replaced by TFT displays in recent years in the portable electronics such as notebook computer, PDA, cell phone and so on. Basically, the rms response requires that the inherent response time of the display be many times longer than the period of the addressing signals. This generally precludes displays having response times short enough to show moving images at video rate. Active addressing and multi-line addressing (MLA) are addressing techniques that generate relatively uniform pixel waveforms and make video-rate operation possible for passive matrix displays. But each MLA implementation has its own trade-offs on performance and overall system complexity. A MLA implementation for a high-end desktop monitor is likely to be quite different from an implementation for a PDA or portable telephone. Regardless of the actual implementation, MLA drive schemes have a common problem that circuitry must be available to perform the multiplication and summation required for the inner product. Economically, the cost for the MLA unit is so high that most LCD producer cannot afford to accept it. Therefore, video-rate display with high contrast ratio is difficult to realize with the prior art technologies.

### SUMMARY OF TE INVENTION

It is the primary object of the present invention to realize a motion video STN display with at least 30 frames per second.

It is another object of the present invention to take advantage of the fast response process of liquid crystal molecules dynamically moving between a small displacement angles.

It is again another object of the present invention to adopt a liquid crystal formulation with low viscosity and ultra high optical anisotropy.

It is a further object of the present invention to design a display cell structure with ultra thin cell gap.

It is still an object of the present invention to dope high concentration of cholesteric twisting agent to the display cell structure to increase restoration speed.

It is another object of the present invention to utilize high contrast ratio, which ensures the high display quality for motion images.

It is again another object of the present invention to devise a simple but effective driving scheme with a high frame rate for a passive multiplexed motion video display.

### THEORATICAL BACKGROUND

Theoretically, STN display could be much faster than other displays because of the following reasons:
1. The liquid crystal molecules in the middle layer of the display cell are just turning much less angle between the optical “ON” state and the optical “OFF” state. For example from 15° to the 60° in the case of 220 degree twisted STN, while in the normal TN display the molecules have to be turning from 0° to 90°. Firstly, a high cross talk bias voltage constantly maintaining the LC molecules in a high pretilt angle, 15° which enables the LC molecules turning much faster than that of from 0° as in the case of TN displays. As a matter of fact, it will take much longer time for a liquid crystal molecule to turn from 0° to 15° than that from 15° to the 60° as it needs to offset the static friction with the planar surface. Secondly, the liquid crystal molecules, in the angle of 60°, are still remaining its chiral nematic state and thus have not accomplished the untwisted chiral nematic state yet as the way that many textbook described before, therefore, the restoring speed or the elastic relaxation process is much faster than it does from 90°.
2. STN design should not be limited to the first or second minimum transmission as the normal TN does where the wave-guiding mode is necessary. Thus allow the cell gap of the STN display reduced to a very small level, for example, as recommended in the present invention, to 3 μm as long as the And meets the requirement of the optic design. This will be remarkably reduced the response time because of the fact that the response time is inverse proportional to the power of the cell gap. The reduction of the cell gap is a decisive factor to the fast response display.
3. With the development of the liquid crystal chemistry, new LC material with ultra low viscosity and high optical birefringence has been accomplished. But the problem was that the liquid crystal material with low viscosity and high optical birefringence usually results in a low contrast ratio of the STN display. It is discovered that if the liquid crystal material has a low dielectric anisotropy, Δε and low Δε/ε⊥ as well as low viscosity, η and high optical anisotropy, Δn, fast response and high contrast ratio will be obtained simultaneously. This is another key factor in the present invention to realize the video rate STN display. Therefore, in the present invention, the applicant uses a self-developed LC formulation to achieve not only video-rate fast response time, but also high display contrast ratio, for example, 50:1 in the transmissive (back lighting) display mode.
4. To achieve a flicker-free video rate display, a driving waveform has to be designed. It is discovered that when the frame rate of the driving waveform is two times more than the normal frame rate of the prior art, a flicker-free motion image could be obtained. Unlike the prior art multi-line-addressing (MLA), the present invention takes advantage of the single line addressing and normal STN driver chips to realize a simple and economical solution to the video rate STN display. Meanwhile, since the frame rate is remarkably increased, the frequency response and the output performance of the driving circuitry become very important to reduce or eliminated the frame response and the cross talk effect occurred in the dynamic driving process.

### BRIEF DESCRIPTION OF THE DRAWINGS

FIG. 1 illustrates the contrast ratio of the video rate STN display.

FIG. 2 illustrates an electro-optical response curve of the video-rate STN display.

### DETAILED DESCRIPTION

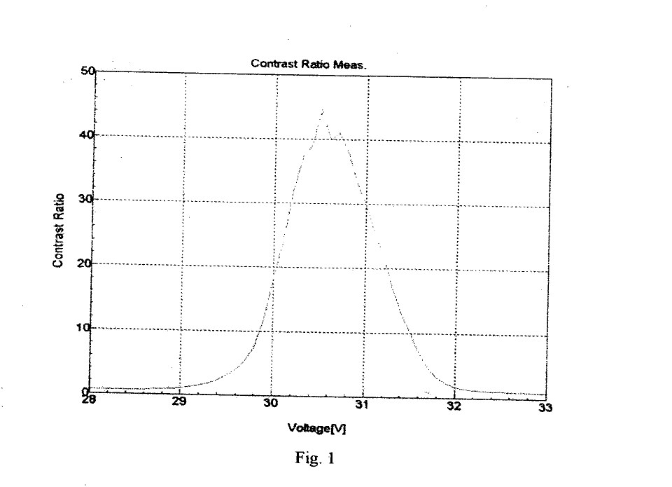

Referring first to FIG. 1, illustrated is a contrast ratio curve over the operation voltage. The operation voltage of the display is set at 31.7 volts and the contrast ratio of the display is 43:1. The display is designed to be a color quarter VGA with a diameter of 5.7″. The cell gap is 3.3 μm and the spacer of the display is chosen as 3.5 μm with the density of 275±25 per mm². The H.P pressure for the cell gap control is 7 kpa. The And of the display cell is 0.831 and the twisting angle is 240°. The liquid crystal mixture is mainly made of TOLAN compounds which have large Δn and low viscosity. A left handed twisting material, S811 is doped into the LC mixture at natural pitch 6.22 μm. Thus the ratio of cell gap to pitch, d/p is 0.53. The liquid crystal material (MDI-STN01) has the following parameters:

| | −25 | 86 | |
|---|---|---|---|
| 1. TRANSITION TEMP | S → | N → I | (° C.) |
| 2. Δn (25° C.) | 0.25 | | |
| 3. Δε | 4.1 | | |
| 4. VISCOSITY (20°) | 23 | | (cp) |
| 5. DOPANT | S-811 | 1.61% | |

The liquid crystal material has low dielectric anisotropy, Δε and low Δε/ε⊥ as well as low viscosity, η, and high optical anisotropy, Δn. Ultra fast response and high contrast ratio have been obtained simultaneously by above-mentioned display parameters compared with other liquid crystal materials available in LC producer worldwise. The operation voltage of the display is 31.7 volts while the other liquid crystal material has lower value, such as 20.5 volts for RDP-89377E1395, produced in DAINIPPON INK & CHEMICALS, INC., JAPAN. But the difference is that under the video rate condition of 30 frames per second, the contrast ratio of the present invention is 43:1 while the control sample using the Japan LC material is only 1.5:1. The higher operation voltage is a positive factor to the video rate STN display and the 31.7 volts close to the standard V_{LCD} of STN power supply, for example 32 volts for a quarter VGA chips. Further research has been carrying out to reduce the operation voltage while maintaining the high contrast ratio to fit into smaller STN displays such as the video rate cell phone display (3G product). Recently, the video rate STN solution working at 26 volts has obtained by the newest LC formulation (MDI-STN02), with the following parameters:

| | −25 | 92 | |
|---|---|---|---|
| 1. TRANSITION TEMP | S → | N → I | (° C.) |
| 2. Δn (25° C.) | 0.23 | | |
| 3. Δε | 8.0 | | |
| 4. VISCOSITY (20°) | 23 | | (cp) |

Higher temperature range of the new LC formulation extends the applications of the video rate STN display, such as DVD player in the auto industry, video signage system and so on.

It is the first time we decrease the cell gap from the prior art 4.5μ to present 3.3μ This has been remarkably reduced the response time because of the fact that the response time is in inverse proportional to the power of the cell gap. Hence, the cell gap control becomes a very important issue for the mass production of the video display especially for the full color STN where an internal color filter layer and over coating layer has to be deposited on the glass substrate in advance. Fortunately, after fine-tuning the production facility, high production yield has achieved for the new video rate STN product.

In order to maintain the ratio of cell thickness to LC pitch d/p, higher doping cholesteric material is necessary. The percentage of S-811 in the nematic liquid crystal is 1.61%, which increase the viscosity of the mixture. Further research is aimed at reducing the cholesteric material while maintaining the same d/p. Some twisting material or the combination of the materials with higher twisting power is promising to be the STN dopant.

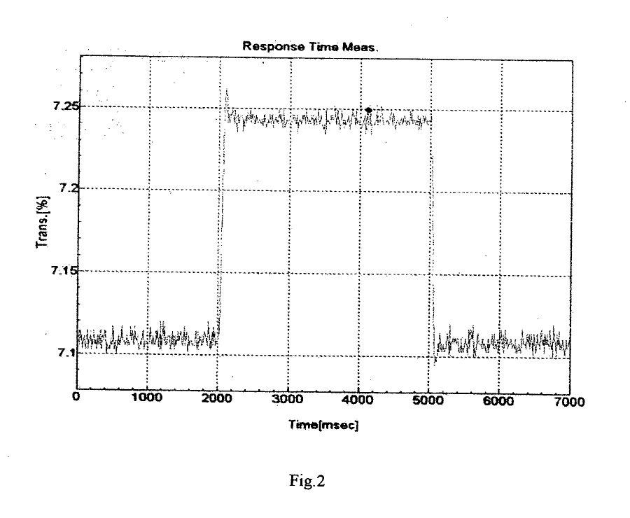

Turning now to FIG. 2, illustrated is a curve of the optical response time. The STN cell structure is the same as described in FIG. 1. The driving voltage is 31.7 volts. The τ_{dr} and τ_{df} are 22.6 ms and 24.6 ms respectively while the τᵣ and the τ_{f} time are 37 ms and 38 ms respectively. Obviously, a video speed can be obtained according the τᵣ and the τ_{f} given by the curve. The video rate response time is attribute firstly, to the liquid crystal formulation, secondly to the thin cell gap, and thirdly to the driving waveform.

The frame rate of the driving waveform should be larger than the normal frame rate of the prior art. In the present invention the frame rate is set at 120 frames/sec which is exactly two times more than the normal rate, 60 frame/sec. At such a frame rate, no flicker or frame response being noticed. It is well known that the traditional rms response requires that the inherent response time of the display be many times longer than the period of the addressing signals. This generally precludes displays having response times short enough to show moving image at video rates. Indeed, if a video-responding, 50 ms panel is operated with Alt and Pleshko addressing at the conventional frame rate of 60 Hz, the breakdown of the rms condition results in a phenomenon known as frame response, where the display no longer responds to the rms voltage averaged over a frame period, but strongly reacts to voltage changes occurring within the frame period. As a matter of fact, the frame response can significantly reduce the optical transmission and contrast ratio because of the rapid decay of the optical transmission that occurs after each select pulse in the pixel waveform.

Instead of using the multi-line addressing (MLA) technique, which is rather complex and very expansive, the present invention adopts a simple but effective addressing method: increasing the frame rate from 60 Hz to 120 Hz while remaining the other driving conditions unchanged. The show-and-tell result of an actual display, a 5.7″ color STN display panel with 320×240 pixels, demonstrates successfully a moving picture without noticeable flicker and frame response. As a result, a video rate STN with 30 frames picture per second has been accomplished.

The video rate STN display with high contrast ratio has upgraded itself to the same performance level as a TFT display in terms of brightness, viewing angle, contrast and response time. There are two advantages of the video rate STN over the TFT: first, the cost of the STN is still much cheaper than that of TFT; and secondly, the aperture ratio of STN can be easily over 80%, while TFT display is very difficult to catch up to the same level. The present invention will enable the STN to play a major role in the emerging LCD desktop monitor as will as the notebook computer.

### EXAMPLE

A video rate color STN sample with dimension of 128 mm×97.4 mm was made according to the following process.

The substrate materials are touch-polished soda-lime glass with coatings to block ion migration.

Transparent Indium-Tin Oxide (ITO) coatings are patterned into row and column electrodes on the two substrates. The front glass is 0.7 mm glass with ITO resistivity of 50 Ω/□ and the back glass substrate has a color filter layer, which has the following parameters:

TABLE 1

| | R | G | B | ITO (Ω/□) |
|---|---|---|---|---|
| X | 0.400 | 0.311 | 0.224 | |
| Y | 0.313 | 0.385 | 0.277 | |
| Z | 50.66 | 74.17 | 46.95 | 13.6 |
| Trans. | At λ = 620 | At λ = 530 | At λ = 460 | |
| | 86.9 | 81.4 | 73.8 | |

The substrates are spaced apart with randomly dispersed 3.5 μm plastic balls having an area density of 275±25 spacers per mm² and final cell gap is controlled at 3.3 μm. The liquid crystal material MDI-STN01 is vacuum filled into the display cell resulting the retardation rate Δnd data listed as following:

TABLE 2

| | 1 | 2 | 3 | Average |
|---|---|---|---|---|
| 1 | 0.835 | 0.829 | 0.834 | 0.833 |
| 2 | 0.831 | 0.824 | 0.832 | 0.830 |
| 3 | 0.829 | 0.825 | 0.832 | 0.829 |
| 4 | 0.831 | 0.830 | 0.836 | 0.834 |
| 5 | 0.832 | 0.833 | 0.836 | 0.834 |
| Max | 0.835 | 0.833 | 0.836 | 0.834 |
| Min. | 0.829 | 0.824 | 0.823 | 0.828 |
| Average | 0.832 | 0.828 | 0.832 | 0.831 |
| Deviation | 0.002 | 0.004 | 0.005 | 0.003 |

The alignment material is a polyimide SE-150 (Nissan Chemical, Japan) which gives the liquid crystal molecules 3˜5° pretilt angle. The rubbing direction for the front panel is −240° and the back panel −60°, relative to the horizontal direction of the display panel.

The polarizer and the retarder being used are Nitto SEG1425DU and RZ435 respectively. And the laminating directions are described as following:

TABLE 3

| | Polarizer | Retarder |
|---|---|---|
| Front Panel | 65° ± 1° | 108° ± 1° |
| Back Panel | 155° ± 1° | 103° ± 1° |

The display results are described as following.

| Response Time (ms) | τᵣ = 37 τ_{f} = 38 |
|---|---|
| Voltage (V) | 31.7 |
| Frame Rate (Hz) | 120 |
| Contrast | 44:1 |

Thus, a video rate STN display has been achieved.

1. An ultra fast display cell structure comprising:
a. a super thin inner cell spacing;
b. a twisted nematic liquid crystal film with low viscosity, high optical anisotropy, low dielectric anisotropy and small helical pitch;
c. a passive electronic driving circuitry with a waveform of ultra high frame-rate;
wherein the liquid crystal film filled into the cell spacing is satisfied substantially with a super twisted angular and optical configurations; and the high frame rate driving waveform is satisfied substantially with the rms addressing requirement of the ultra fast display cell structure;
whereby a video speed display with high contrast ratio is formed.

2. The display as in claim 1 wherein the super thin inner cell spacing is a cell gap with the thickness of 2˜5 μm, more preferably, 3˜4 μm.

3. The display as in claim 1 wherein the high optical anisotropy is an optical birefringence, Δn, with a value of 0.2˜0.3, more preferably, 0.23˜0.27.

4. The display as in claim 1 wherein the low dielectric anisotropy, Δε, is in the range of 2˜8 which results in high display contrast ratio.

5. The display as in claim 1 wherein the small helical pitch, p₀, is in the range of 5˜8 which results in fast restoring time.

6. The display as in claim 1 wherein the ultra high frame rate is the frame rate at least 120 Hz, which is two times higher than the normal frame rate of the STN display.

7. The display as in claim 1 wherein the video speed is at least 30 frames per second.

8. A liquid crystal characteristics for video rate STN display comprising:
a. low viscosity;
b. high optical birefringence;
c. high threshold voltage;
d. small helical pitch;
e. low dielectric anisotropy;
wherein low viscosity and small helical pitch is for fast response time, high optical birefringence is for the optimal retardation at a thin cell gap and high threshold voltage and low dielectric anisotropy are for the high contrast ratio;
whereby the liquid crystal ensures the video speed display while maintaining high contrast ratio.

9. The liquid crystal characteristics as in claim 8 wherein the viscosity is in the range of 15˜25 cp at 20° C.

10. The liquid crystal characteristics as in claim 8 wherein the high optical birefringence, Δn, is in the range of 0.2˜0.3, more preferably, 0.23˜0.27.

11. The liquid crystal characteristics as in claim 8 wherein the low dielectric anisotropy, Δε, is in the range of 2˜8 which results in high display contrast ratio.

12. The liquid crystal characteristics as in claim 8 wherein the small helical pitch, p₀, is in a range of 5˜8.

13. The liquid crystal characteristics as in claim 8 wherein the high contrast ratio is larger than 40:1.

14. An electronic driving circuitry for the video speed STN display comprising:
a. a row driver with high frequency response;
b. a column driver with superior output capability;
c. a controller which generate a high frame rate pulses for both row and column drivers through a synchronizing signal;
d. a high frequency frame inverting circuit to change the polarity of the waveform for off-setting the DC component of the accumulate waveforms;
whereby a high frame rate waveform is generated for the video speed STN display.

15. The electronic driving circuitry as in claim 14 where the row driver with high frequency response ensures substantially no horizontal cross talk at high frame rate.

16. The electronic driving circuitry as in claim 14 where the column driver with super output capability ensures substantially no vertical cross talk at high frame rate.

17. The electronic driving circuitry as in claim 14 where the high frame rate is at least 120 Hz, which is two times more than the prior art.

18. The electronic driving circuitry as in claim 14 where the high frame rate ensures substantially flicker-free display result.

19. The electronic driving circuitry as in claim 14 where the high frame rate ensures substantially no frame response.

20. The electronic driving circuitry for the video speed STN display ensures at least 30 frames of images per second without substantial signal distortion.
